(19) United States
(12) Patent Application Publication
(10) Pub. No.: US 2004/0098833 A1
(43) Pub. Date: May 27, 2004

(54) Hinge for a mobile phone

(75) Inventors: Sheng-Nan Lu, Shulin City (TW); Hsiang-Chi Chien, Shulin City (TW)

Correspondence Address: Jackson Walker L.L.P., Suite 2100, 112 E. Pecan Street, San Antonio, TX, 78205, US

(73) Assignee: Shin Zu Shing Co., Ltd.

(21) Appl. No.: 10/305,618

(22) Filed: Nov. 27, 2002

(51) Int. Cl. E05D 11/10

(52) U.S. Cl. 16/336

(57) ABSTRACT

A hinge for a mobile phone is composed of a barrel, two positioning sheets, and a pintle. The barrel is installed in a cover of the mobile phone, and the pintle is installed in the body of the mobile phone and received in the barrel. The positioning sheets are secured in the barrel, and respectively abut two flat surfaces of the pintle. When the cover is pivoted about the body upwards or downwards to a certain position, under the force of the positioning sheets, the barrel can be automatically and rapidly pivoted further to raise or close the cover.

### BACKGROUND OF THE INVENTION

1. Field of the Invention

The present invention is related to a mobile phone, and more particularly to a hinge for a mobile phone by which a cover can be pivotally mounted on a body of the mobile phone.

2. Description of Related Art

Some mobile phones have a cover pivotally mounted on a body by a hinge, wherein the cover has an LCD monitor installed therein, and the body has a keyboard installed therein.

However, the cover mounted on the body by some conventional hinges cannot automatically open or close, so that a user must continuously turn the cover until the cover is completely raised or abutting the body, which is very inconvenient. In other conventional hinges, resilient members are provided to give the cover a function to automatically open or close. However, the resilient members usually are compressed in the closed status or the open status and will lose elasticity after a short time.

Therefore, the invention provides a hinge to mitigate and/or obviate the aforementioned problems.

### SUMMARY OF THE INVENTION

The main objective of the invention is to provide a hinge for a mobile phone by which a cover can automatically pivot about a body of the mobile phone.

Another objective of the invention is to provide a hinge for a mobile phone that can be used effectively over a long time.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge for a mobile phone in accordance with the invention;

FIG. 2 is a sectional front view of the hinge in FIG. 1;

FIG. 3 is a sectional side view of the hinge in FIG. 2;

FIG. 4 is a perspective view of a mobile phone assembled with the hinge; and

FIG. 5 is a sectional side view of the hinge in a pivoting status.

### DETAILED DESCRIPTION OF THE PREFERRED EMBODIMENT

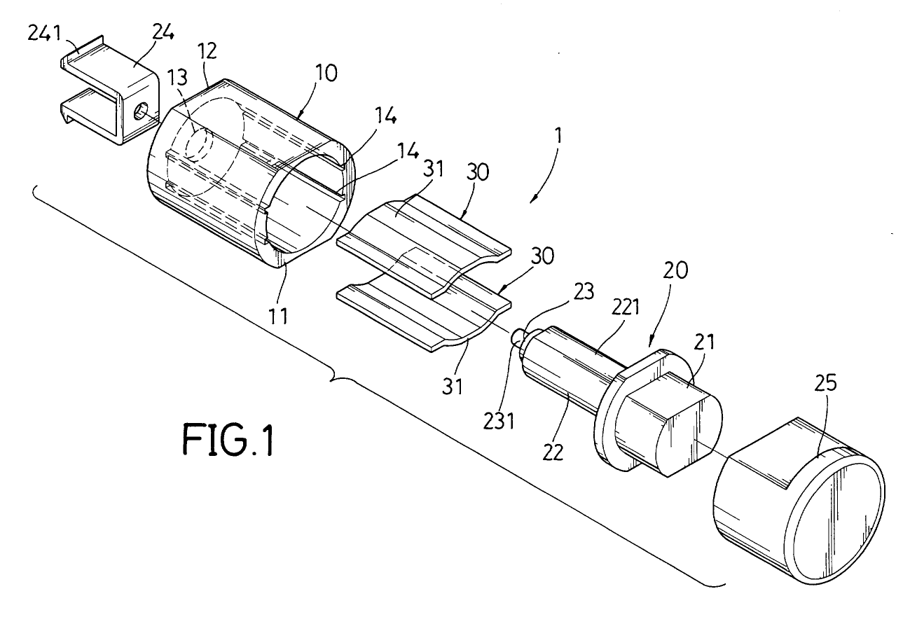

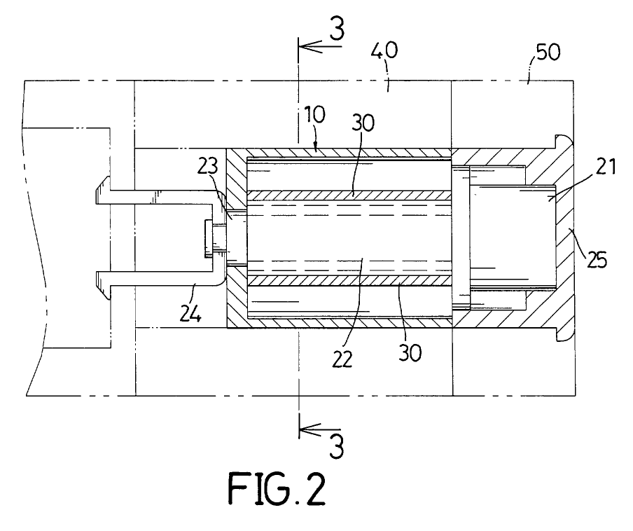

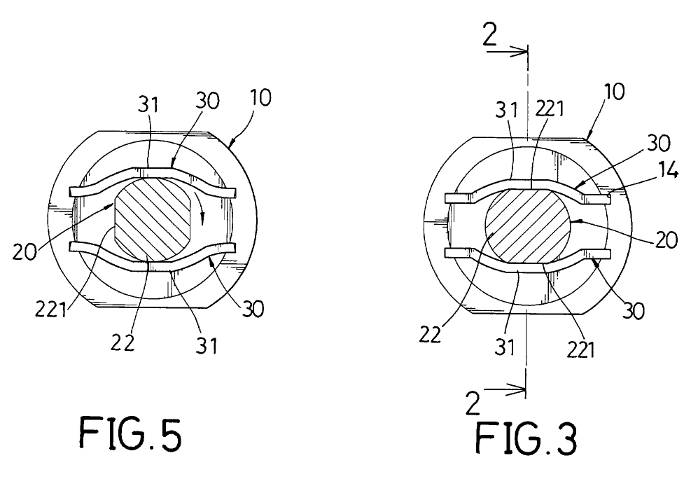

Referring to FIGS. 1-3, a hinge (1) for a mobile phone in accordance with the present invention is composed of a barrel (10), a pintle (20), and two positioning sheets (30).

The barrel (10) has a first end (11) and a second end (12). A central hole (13) is defined through the second end (12). Four channels (14) are longitudinally defined in pairs and diametrically oppositely formed at an inner wall of barrel (10).

The pintle (20) pivotally mounted in the barrel (10) has a first part (21), a second part (22), and a third part (23). A flange (not numbered) is formed between the first part (21) and the second part (22). An end cover (25) is provided outside the first part (21) of the pintle (20). The second part (22) has two flat surfaces (221) respectively formed at two diametrically opposite sides thereof. The second part (22) is pivotally received in the barrel (10) from the first end (11), and the third part (23) extends out from the central hole (13) of the second end (12). A recess (231) is circumferentially defined at an outer periphery of the third part (23). A U-like collar (24) is secured to the recess (231) to fasten the pintle (20). The collar (24) has a central portion (not numbered) and two arms (not numbered) extending from the central portion. Two barbs (241) are respectively formed at distal ends to attach the pintle in a mobile phone.

The positioning sheets (30) are mounted in the barrel (10), and each have two edges (not numbered) received in the respective channels (14) of the barrel (10). An arched portion (31) is formed at the middle of the positioning sheet (30). The second part (22) is positioned between the positioning sheets (30), and the flat surfaces (221) of the pintle (20) respectively abut the arched portions (31). Under the elastic force of the positioning sheets (30), the pintle (20) is tightly positioned in the barrel (10).

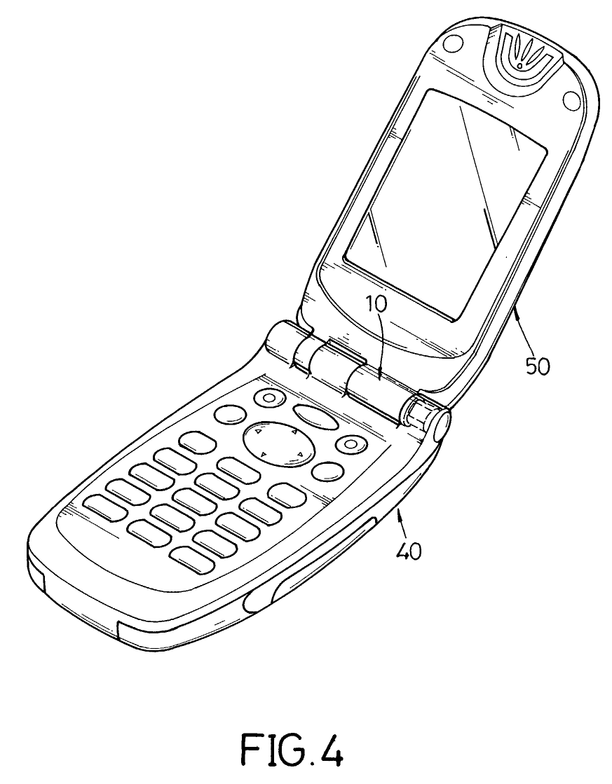

Referring to FIG. 4, the mobile phone has a body (40) and a cover (50). The pintle (20) is secured in the body (40), and the barrel (10) is installed in the cover (50).

When the cover (50) abuts the body (40), the arched portions (31) of the positioning members (30) abut the flat surfaces (221) to position the pintle (20) in the barrel (10). Referring to FIG. 5, when the user raises the cover (50), the barrel (10) along with the positioning members (30) is pivoted about the pintle (20), and the flat surfaces (221) are disengaged from the arched portions (31). The circumferential surfaces of the second part (22) between the flat surfaces (221) respectively abut the positioning sheets (30), and a distance between the positioning sheets (30) is increased. Under the resilient force of the positioning sheets (30), the barrel (10) cannot stably stop at the circumferential surfaces without an external force from the user, and has a tendency to further rotate until the arched portions (31) respectively abut the flat surfaces (221) opposite to the original ones. Then, the cover (50) is opened and positioned.

A closing process to pivot downwards the cover (50) is similar to the process as hereinbefore, and will not be described in detail.

Therefore, according to the present invention, when the user pivots the cover (50) to a certain position, under the force of the positioning sheets (30), the barrel (10) can be automatically and rapidly pivoted further to raise or close the cover (50). Furthermore, at the open or closed position, the arched portions (31) abutting the flat surfaces (221) are of the original configuration without deformation, so that the hinge can be used effectively for a long time.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge (1) for a mobile phone, the mobile phone having a body (40) and a cover (50), the hinge comprising;
a barrel (10) secured in the cover (50) of the mobile phone, the barrel (10) having a first end (11), and a second end (12);
two positioning sheets (30) installed in the barrel (10), each positioning sheet (30) having an arched portion (31) formed at the middle of the positioning sheet (30); and
a pintle (20) rotatably mounted in the barrel (10), the pintle (20) having a first part (21) secured in the body (40) of the mobile phone, a second part (22) received in the barrel (10) through the first end (11), and two flat surfaces (221) diametrically oppositely formed at an outer periphery of the second part (22) and respectively abutting the arched portions (31) of the positioning sheets (30).

2. The hinge as claimed in claim 1, wherein the barrel (10) has a central hole (13) defined through the second end (12); and the pintle (20) has a third part (23) extending through the central hole (13), a recess (231) circumferentially defined at an outer periphery of the third part (23), and a collar (24) installed in the recess (231) to fasten the pintle (20) in the barrel (10).

3. The hinge as claimed in claim 2, wherein the collar (24) has a central portion, two arms extending from the central portion, and two barbs (241) formed at distal ends of the arms to attach to the mobile phone.

4. The hinge as claimed in claim 1, wherein the barrel (10) has four channels (14) longitudinally defined in pairs and diametrically oppositely defined in an inner wall thereof, and the positioning sheets (30) each have two sides respectively received in the channels.

5. The hinge as claimed in claim 1, wherein the pintle (20) has an end cover (25) provided outside the first part (21).
